(19) United States
(12) Patent Application Publication
(10) Pub. No.: US 2014/0113270 A1
(43) Pub. Date: Apr. 24, 2014

(54) SYSTEM AND METHOD FOR MOBILE AUTOMATED TRAINING

(71) Applicant: George E. Danis, Hudson, MA (US)

(72) Inventor: George E. Danis, Hudson, MA (US)

(21) Appl. No.: 14/057,386

(22) Filed: Oct. 18, 2013

Related U.S. Application Data
(60) Provisional application No. 61/716,387, filed on Oct. 19, 2012.

(51) Int. Cl. G09B 5/02

(52) U.S. Cl. CPC G09B 5/02
USPC 434/365

(57) ABSTRACT

Described herein are methods and apparatus for providing mobile automated training. In certain embodiments, the disclosed technology includes a mobile automated trainer for providing real time training to operators while the operator is performing the task for which they are receiving the training. In some implementations, the training is provided in normal work situations and/or environments. In certain embodiments, the disclosed technology includes a mobile automated trainer. The mobile automated trainer may include a computing device and video monitor mounted on a moveable stand. The operator may view training materials on the mobile automated trainer for a task they are performing while actually performing the task or immediately before performing the task in addition to other times as well.

### RELATED APPLICATIONS

The present application claims priority to U.S. provisional application No. 61/716,387, filed Oct. 19, 2013, the entire contents of which are incorporated by reference.

### BACKGROUND

Training is used in the workplace and elsewhere to provide individuals with the knowledge, skills, and competencies necessary to perform certain tasks. In the context of the workplace, training is often performed away from the normal work environment. Not only is the environment different, but the tools, machines, devices, documents, and/or materials used in the normal work environment are absent from a training room.

Furthermore, training is often performed before an individual performs a task. The individual may not be aware of the environment where the task will be performed, the physical demands of performing the task, issues that may arise while performing the task, as well as other information related to the task for which they will receive training. This impacts the ability of the individual to transfer information provided during training to practice when they actually perform the task.

Often training involves reviewing a book, paperwork, or other materials. However, an individual may not find the time necessary to adequately review all of these materials and the effectiveness of training may be reduced. For example, in the context of a manufacturing facility, a quality assurance manager may compile hundreds of training manuals that describe various tasks that occur at a manufacturing facility such as operating machines, sorting parts, identifying defects, and packaging parts. However, it may be difficult to get employees of the manufacturing facility to actually read all of the training manuals. Furthermore, it may be difficult to get employees to review the training manuals when they need them because they are lost, cumbersome, or difficult to use.

### SUMMARY

Described herein are methods and apparatus for providing mobile automated training. In certain embodiments, the disclosed technology includes a mobile automated trainer for providing real time training to operators while the operator is performing the task for which they are receiving the training. In some implementations, the training is provided in normal work situations and/or environments.

In certain embodiments, the disclosed technology provides visual and/or audio training instructions to an operator while the operator is performing a task associated with the training instructions. The disclosed technology, in certain embodiments, provides continuous audio and visual reinforcement while the operator is performing the task. For example, in certain embodiments, an employee of a manufacturing facility may be assigned with the task of identifying defective parts produced by a machine. The disclosed technology may provide for a mobile automated trainer located at the employee's work station and the mobile automated trainer may provide instructions on how to identify defective parts, examples of defective parts, what to do with defective parts, what to do with non-defective parts, and/or how to package non-defective parts. In certain embodiments, the mobile automated trainer is used to train new employees in other types of companies.

In certain embodiments, the disclosed technology includes a mobile automated trainer. The mobile automated trainer may include a computing device. The computing device may be a mobile computing device. The computing device may be mounted on a moveable stand. The computing device may include a monitor where the operator of the mobile automated trainer may view training materials associated with a task the operator wants to perform. The operator may view training materials on the mobile automated trainer for a task they are performing while actually performing the task or immediately before performing the task in addition to other times as well. If the operator wishes to perform a different task, such as when the operator moves to a new machine on a manufacturing floor and wishes to receive training on the new machine, the operator may bring the mobile automated trainer with them and view training materials for the new task.

The mobile automated trainer may also be used to train new employees beyond the classroom. As explained in the context of a manufacturing facility, the mobile automated trainer could be located at each machine the new employee is going to use or the new employee may simply bring the mobile automated trainer with them to each station where they will work throughout the day. The new employee may receive training while working without the need for additional employees to supervise the new employee throughout the day.

In certain embodiments, the disclosed technology provides revision and update control such that operators using the mobile automated trainer always receive the most up to date training. Furthermore, version control may provide additional security related to the electronic training materials and any information included in the electronic training materials.

In certain embodiments, a mobile automated training apparatus includes a mobile stand configured for moving between at least two training locations in a facility; a video monitor attached to the mobile stand, the video monitor being adjustable between at least two height positions; a processor; and a non-transitory computer readable medium storing instructions thereon wherein the instructions, when executed, cause the processor to: display one or more GUI widgets on the monitor for selection by an operator, wherein each of the one or more GUI widgets corresponds to a set of electronic training materials to be presented on the video monitor; and upon selection of one of the one or more GUI widgets by the operator, display the corresponding set of electronic training materials on the video monitor.

In certain embodiments, the at least two training locations include a location at which a task is performed by the operator and the set of electronic training materials displayed on the video monitor relate to the task performed at said location.

In certain embodiments, the mobile stand configured for moving between at least two training locations in a facility includes one or more wheels for moving the mobile stand between the at least two training locations.

In certain embodiments, the facility is at least one of a manufacturing facility, a hotel, a kitchen, an office, bar, academic institution, medical facility, and operating room.

In certain embodiments, the mobile automated training apparatus further includes a user interface device including at least one of a keyboard, a computer mouse, a trackball, a touch screen, a hands free communication device, and a microphone. The user interface device may be configured to facilitate selection of the graphical user interface widgets by the operator.

In certain embodiments, the video monitor includes a touch screen configured to facilitate selection of the graphical user interface widgets by the operator.

In certain embodiments, the one or more graphical user interface widgets include one or more members selected from the group consisting of a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and a scroll bar.

In certain embodiments, the set of electronic training materials includes one or more members selected from the group consisting of a part description, a diagram, an operation instruction, a slideshow, a video, an audio message, and a training instruction manual.

In certain embodiments, the set of electronic training materials is version-controlled.

In certain embodiments, the video monitor is adjustable between a first position for viewing by a sitting operator and a second position for viewing by a standing operator.

In certain embodiments, the method of providing mobile automated training includes: displaying, at a computing device of a mobile automated training apparatus, one or more GUI widgets, each corresponding to a set of electronic training materials for display on a video monitor of the mobile automated training apparatus; identifying, at the computing device of the mobile automated training apparatus, an operator selection of one of the one or more GUI widgets; receiving from a file server, at the computing device of the mobile automated training apparatus, a version-controlled set of electronic training materials for display on a video monitor of the mobile automated training apparatus, wherein the set of electronic training materials corresponds to the selected GUI widget.

In certain embodiments, the mobile automated training system includes (a) a mobile automated training apparatus including: a mobile stand configured for moving between at least two training locations in a facility; a video monitor attached to the mobile stand, the video monitor being adjustable between at least two height positions; a processor; and a non-transitory computer readable medium storing instructions thereon wherein the instructions, when executed, cause the processor to: display one or more GUI widgets on the monitor for selection by an operator, wherein each of the one or more GUI widgets corresponds to a set of version-controlled electronic training materials to be presented on the video monitor; upon selection of one of the one or more GUI widgets by the operator, receive a set of version-controlled electronic training materials corresponding to the selected GUI widget from a file server; and display the corresponding set of version-controlled electronic training materials on the video monitor; and (b) a file server configured to: store a version-controlled set of electronic training materials corresponding to each of the one or more GUI widgets; and transmit the set of version-controlled electronic training materials corresponding to the selected GUI widget to the processor of the mobile automated training apparatus.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A-1F are illustrations of an example mobile automated training system as well as examples of mobile automated trainers and components of an example mobile automated trainer;

FIG. 2 is a flow chart describing a method of providing training to an operator using a mobile automated trainer;

FIGS. 3A-3C are diagrams of methods for interacting with a mobile automated trainer and providing mobile automated training to an operator of the mobile automated trainer;

FIGS. 4A-4E illustrate examples of electronic training materials that may be displayed on a mobile automated trainer;

FIG. 5 illustrates an example of a graphical user interface provided on a monitor of a mobile automated trainer for selecting electronic training materials;

FIG. 6 illustrates an example of a graphical user interface provided on a monitor of a mobile automated trainer for displaying a list of parts that may be made by a machine;

FIG. 7 illustrates an example of a graphical user interface provided on a monitor of a mobile automated trainer for displaying a list of one or more electronic training materials associated with a machine, part, or task for which the operator wants to receive training;

FIG. 8 shows a block diagram of an exemplary cloud computing environment;

FIG. 9 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the disclosed technology provides visual and audio training instructions to an operator while the operator is performing a task associated with the training instructions. In some implementations, the disclosed technology includes a mobile automated trainer for providing training. In some implementations, training includes visual and audio based training instructions. The mobile automated trainer may be used to provide operators with electronic training materials at a time when training is most effective. In some implementations, training is most effective when the operator is performing the task for which they are receiving training.

For example, in some implementations, an employee of a manufacturing facility may be assigned with the task of identifying defective parts produced by a machine. The disclosed technology may provide for a mobile automated trainer located at the employee's work station and the mobile automated trainer may provide instructions on how to identify defective parts, examples of defective parts, what to do with defective parts, what to do with non-defective parts, and/or how to package non-defective parts.

The mobile automated trainer may also be used to train new employees beyond the classroom. As explained in the context of a manufacturing facility, the mobile automated trainer could be located at each machine the new employee is going to use or the new employee may simply bring the mobile automated trainer with them to each station where they will work throughout the day. The new employee may receive training while working without the need for additional employees to supervise the new employee throughout the day.

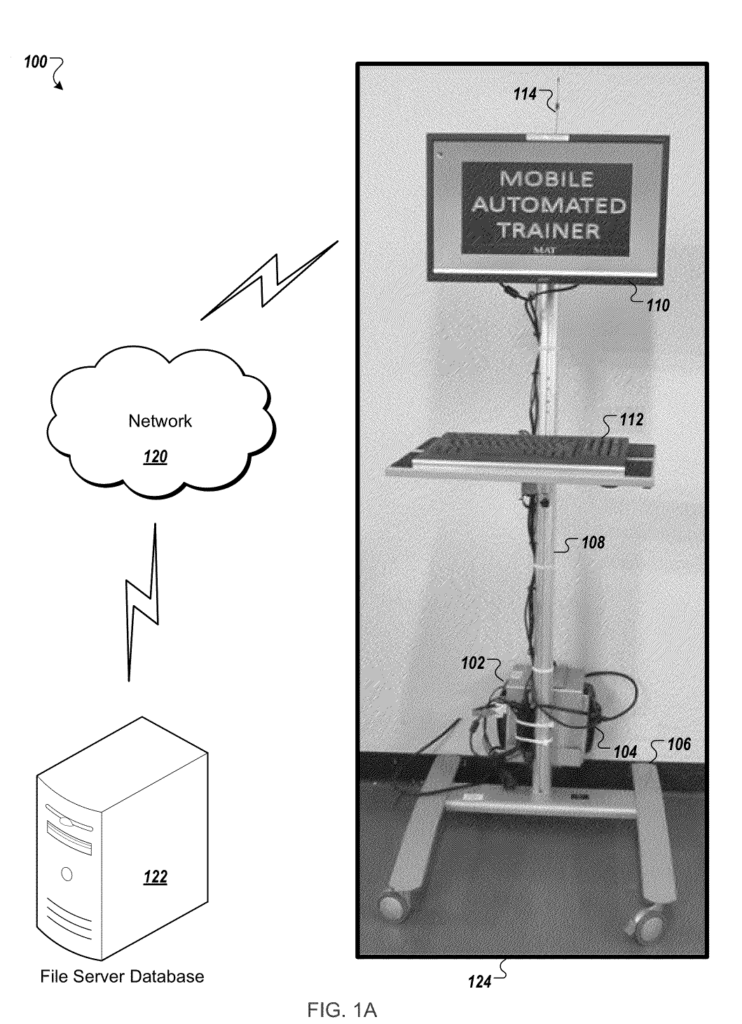

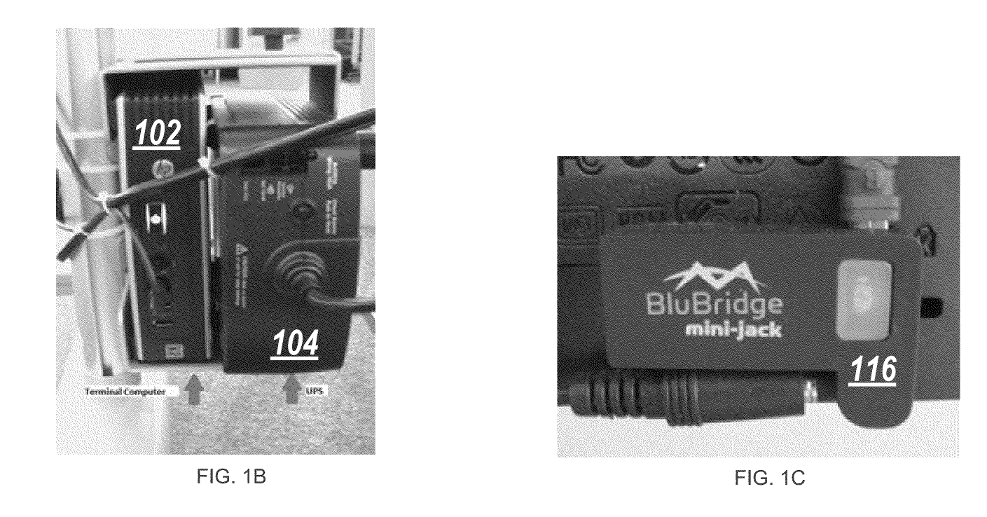

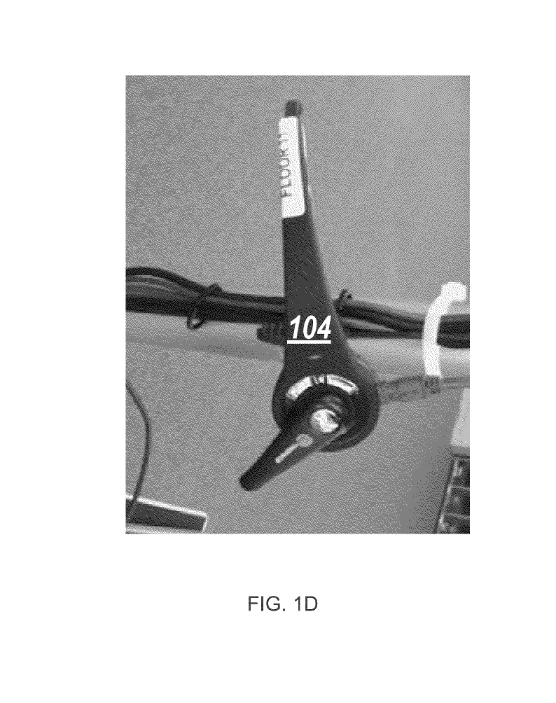

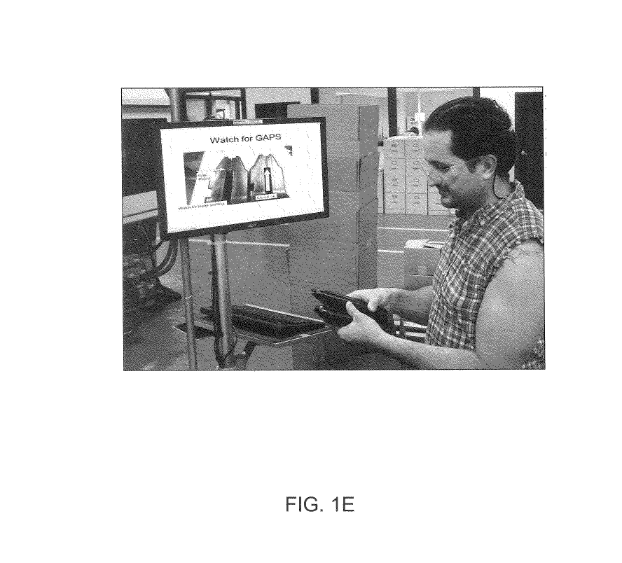

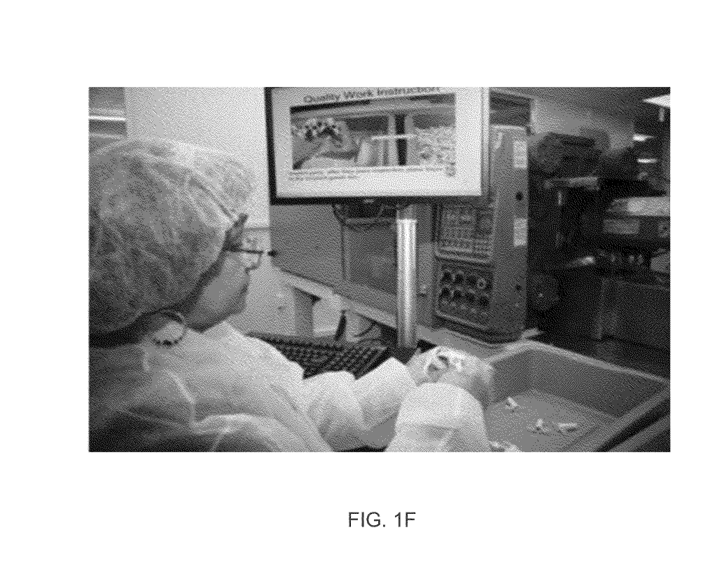

FIGS. 1A through 1F illustrate a mobile automated training system 100 as well as example mobile automated trainers. In some implementations, the mobile automated trainer 124 may be used in a manufacturing facility (e.g. electronics, plastics, and/or chemical manufacturing facility), a hotel for training housekeepers, a kitchen to train a chef, an office to train employees, or any other situation where an operator needs training and/or lessons on how to complete a task.

In some implementations, as shown in FIG. 1A-1C, the mobile automated trainer 124 includes a computing device 102. The computing device 102, in some implementations, is a laptop, desktop, workstation, server, blade server, mainframe, and/or mobile computing device, such as a personal digital assistant, cellular telephone, smart phone, tablet computing device, or portable music player.

The computing device 102 may run a mobile automated trainer software application. In some implementations, the mobile automated trainer software application is a software application that is stored locally on the mobile automated trainer 124. The application may run on the mobile automated trainer computing device 102 and communicate with the file server database (FSD) 122. In some implementations, the mobile automated trainer software application is a web browser that accesses the FSD 122 through a web portal.

In some implementations, the mobile automated trainer 124 includes a monitor 110 for displaying the graphical user interface associated with the mobile automated trainer software application, including displaying electronic training materials. In some implementations, the electronic training materials include one or more part descriptions, diagrams, operation instructions, recipes, job instructions, slideshows, videos, audio messages, instructions, and/or other electronic training materials. In some implementations, the electronic training materials may be accessed in multiple languages.

In some implementations, the monitor 110 is a touch screen monitor for receiving input commands from the operators receiving training. In some implementations, the computing device receives user input from a keyboard 112, a computer mouse, trackball, touch screen, hands free communication device, and/or voice commands.

In some implementations, the mobile automated trainer 124 includes a wireless audio unit 116 that may communicate with a wireless headset 118. An operator may use the wireless headset 118 to listen to electronic training materials. In some implementations, the headset is a wired headset.

In some implementations, the mobile automated trainer 124 includes a wireless communications unit 114 that provides for communication with a network connected to a file server database (FSD) 122. In some implementations, wireless communication is via a wife connection. In some implementations, the wireless communications unit 114 is installed on the top of the mobile automated trainer 124. In some implementations, the wireless communications unit 114 is an antenna.

In some implementations, the mobile automated trainer 124 is powered via a power cord. In some implementations, the mobile automated trainer 124 is powered by a battery 104. In some implementations, the battery 104 is rechargeable via a power cord. In some implementations, battery 104 is an uninterruptible power supply. The battery 104, in some implementations, is used to move the mobile automated trainer 124 between work stations without turning off the computer. The battery 104 may automatically kick in when the mobile automated trainer 124 is unplugged from a power outlet. The mobile automated trainer 124 may then be moved to a new location where it can again be plugged in without having to shut off the whole system. In some implementations, the battery 104 is charged while the mobile automated trainer 124 is plugged into a power outlet.

In some implementations, the mobile automated trainer 124 includes base 106 with wheels for mobility. The mobile automated trainer 124 may be wheeled from a first work station to a second work station where the operator may receive training tailored to the task performed at the second work station. In some implementations, the mobile automated trainer 124 includes a mounting arm 108 attached to the base 106. The mounting arm 108 may be adjustable such that the height of the display 110 and/or keyboard 112 (if included) are raised or lowered. The height of the display 100 and/or keyboard 112 may be adjusted for a seated operator or a standing operator. Whether the operator is standing or sitting may be based on the task the operator is performing.

In some implementations, the mobile automated trainer 124 is designed to be a mobile unit for accessing training information relevant to a task. In some implementations, the task is performed by an operator and the operator may use the mobile automated trainer 124 prior to performing the task, while performing the task, and/or after performing the task. In some implementations, the operator may use the mobile automated trainer 124 immediately before performing the task. In some implementations, the mobile automated trainer 124 may be used to train an operator how to identify faulty parts as the operator performs the task as shown in FIGS. 1D and 1E.

In some implementations, the mobile automated trainer 124 is designed to be a mobile unit for accessing electronic training materials for a task that is assigned to an operator. The electronic training materials that pertain to the task may be held in a file repository located on a file server database (FSD) 122. In some implementations, the FSD is one or more servers, databases, mainframes, computer systems, and/or networks.

In some implementations, the mobile automated trainer 124 uses the mobile automated trainer software application that allows the operator to log in and access the FSD. In some implementations, the mobile automated trainer 124 accesses the FSD 122 using a network 120 such as a public network, the Internet, and a private network. In some implementations, the mobile automated trainer 124 connects to the FSD 122 via a wireless Internet connection, wireless data connection, and/or hard wired connection.

In some implementations, the electronic training materials are selected by the operator for training purposes. The operator may select the file and the file may play within the mobile automated trainer software application or may launch in a third party software application.

In some implementations, the electronic training materials are auto-started based on the location of the mobile automated trainer 124. The mobile automated trainer 124 determines its location using a GPS, wireless triangulation device, or other location determining device. The mobile automated trainer 124 may use its location to launch electronic training materials based on the location of the device. In some implementations, the mobile automated trainer 124 uses the location to launch a list of electronic training materials based on the location of the device. For example, when the mobile automated trainer 124 is brought to a specific location, such as near a certain machine, a training file for that machine may be launched by the mobile automated trainer software application. Accordingly, the operator may receive task related training from the mobile automated trainer 124 at the location where they will perform the task, thus improving training effectiveness.

In some implementations, the mobile automated trainer 124 location is determined by plugging the mobile automated trainer 124 into a device. The device may be a network device. In some implementations, the mobile automated trainer 124 location is determined by docking the mobile automated trainer 124 in a docking station associated with a specific machine, part, or task.

In some implementations, MAT 124 is equipped with a RIFD reader and/or writer (reader/writer). In some implementations, the RFID reader/writer may be a NFC reader/writer. In some implementations, locations where training is performed are marked with RFID or NFC chips. The mobile automated trainer 124 RFID reader/writer may be used to scan a RFID/NFC chip. In some implementations, when the chip is scanned, the mobile automated trainer 124 launches electronic training materials associated with the chip that was scanned. In some implementations, the mobile automated trainer 124 launches a list of electronic training materials associated with the chip that was scanned. In some implementations, the chip will be associated with electronic training materials relevant to the location of the chip. In some implementations, the chip will be associated with electronic training materials for a machine or device on which the chip is mounted.

The mobile automated trainer 124 may use the mobile automated trainer software application to access the FSD 122 and receive the electronic training materials. In some implementations, the computing device 102 acts as a terminal and is used for sending requests to the FSD 122 and displaying the results. In some implementations, the software for displaying the selected documents or electronic training materials is installed on the computing device 102. In some implementations, electronic training materials are viewed on the mobile automated trainer software application. In some implementations, the electronic training materials are streamed to the computing device 102.

The FSD 122 may store username and password information. In some implementations, if the mobile automated trainer 124 is used in a manufacturing facility, the FSD 122 stores the types of tasks that are performed by one or more machines at the manufacturing facility. The mobile automated trainer 124 may then be used to access electronic training materials associated with a machine at the manufacturing facility. In some implementations, the FSD 122 also stores the location of the electronic training materials, the electronic training materials themselves, and/or documents related to the tasks.

In some implementations, the mobile automated training system 100 includes version control software. The version control software may be an independent software application running on the FSD 122, an independent software application running on another computer system, or part of a software application running on the FSD 122. In some implementations, the electronic training materials are stored in a protected repository for version control. The protected repository may be on the FSD 122 system or it may be part of a version control software program. In some implementations, version control includes automatic versioning so that old electronic training materials cannot be accessed by the mobile automated trainer 124. In some implementations, version control includes document archiving so that old versions of electronic training materials may be accessed in the future by the mobile automated trainer 124 or an administrator.

In some implementations, version control software maintains current links to documents, and/or store and retrieve electronic training materials stored on the FSD 122. In some implementations, the version control software communicates with the mobile automated trainer software application. In some implementations, the version control software and the mobile automated trainer software application are incorporated into one software application.

In some implementations, the electronic training materials are not stored locally on the mobile automated trainer 124. Networked storage of the electronic training materials, e.g. not storing the electronic training materials locally, provides a system for version control and/or update management. Accordingly, versions and/or updates to the electronic training materials in the FSD 122 may always be delivered to the mobile automated trainer 124 when requested. Thus, operators receiving training on a given task will receive the most recent electronic training materials each time they use the mobile automated trainer 124. Additionally, networked storage of the electronic training materials provides an additional layer of security relating to the electronic training materials themselves.

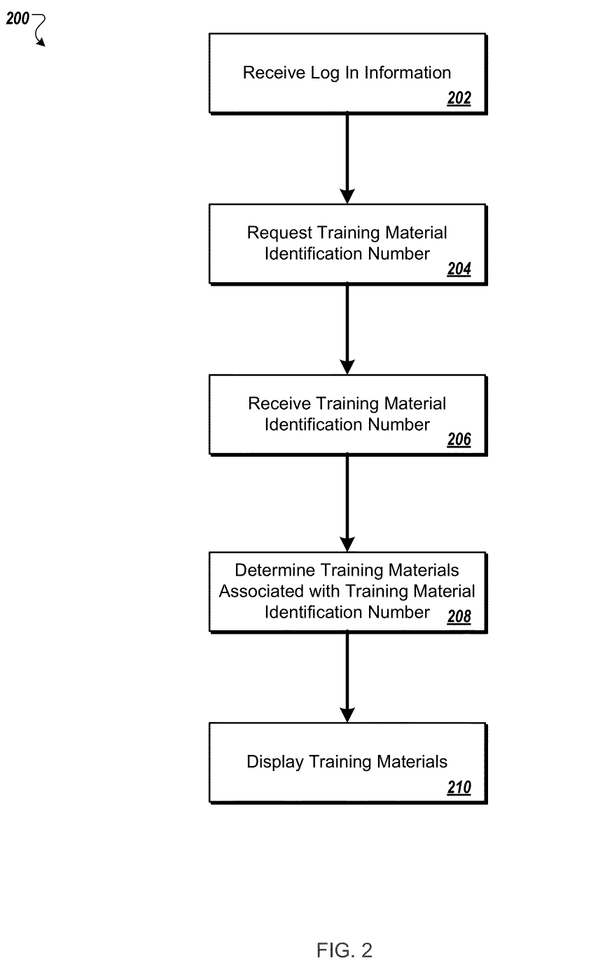

FIG. 2 illustrates a flow chart describing a method 200 of providing training to an operator using a mobile automated trainer.

In some implementations, an operator moves the mobile automated trainer to a location where they are going to perform a task. In some implementations, the mobile automated trainer is positioned at the location where the operator is going to perform a task. In some implementations, the operator will want to receive training before performing the task or while performing the task. In some implementations, the mobile automated trainer is used to perform a review after a task has been performed.

In some implementations, an operator logs into a system and a file server database (FSD) receives the log in information (202). The FSD may authenticate the log in information before continuing.

In some implementations, the FSD will request a machine number, part number, or task for training (204). In some implementations, the operator enters the relevant number, scans a barcode, plugs in a cables associated with a task, machine, or part, docks the mobile automated trainer in a docking station, and/or scans a RFID chip (as discussed above) to provide the FSD with the relevant number. In some implementations, the FSD will determine the relevant task to be performed based on the location of the mobile automated trainer.

After receiving the number associated with the machine, part, or task to be performed (206), the mobile automated trainer determines the electronic training materials associated with that machine, part, or task (208). The electronic training materials may include part descriptions, diagrams, operation instructions, slide shows, videos, audio messages, instructions, and/or other electronic training materials relevant to the machine, part, or task number provided.

In some implementations, the FSD displays electronic training materials based on the electronic training materials determined in step 208 (210). In some implementations, the FSD displays a list of electronic training materials on a display screen on the mobile automated trainer and the operator may select which electronic training materials to view. In some implementations, the FSD will automatically display the electronic training materials determined in step 208.

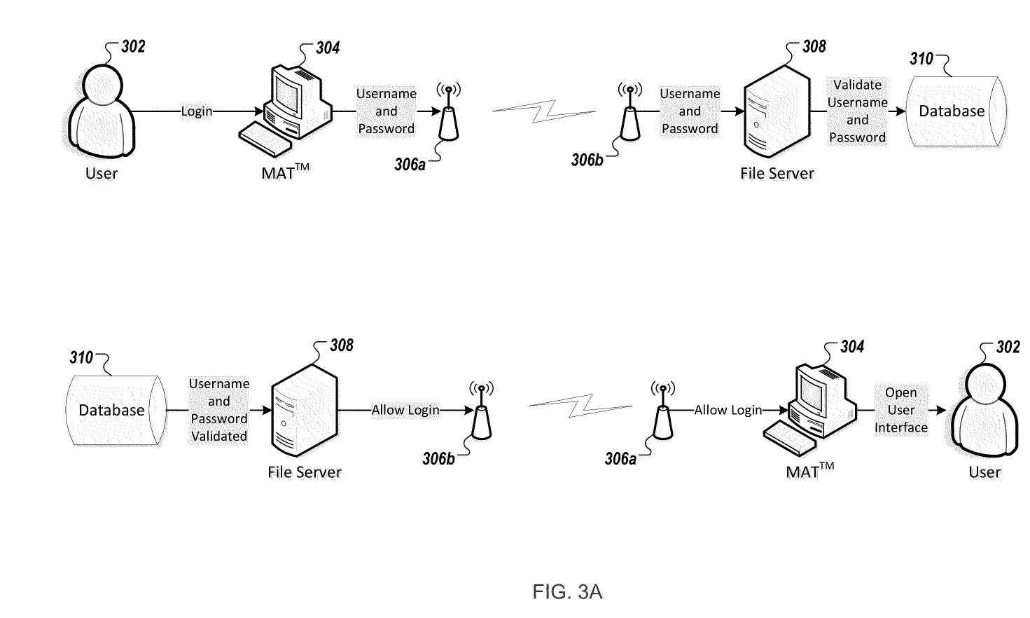

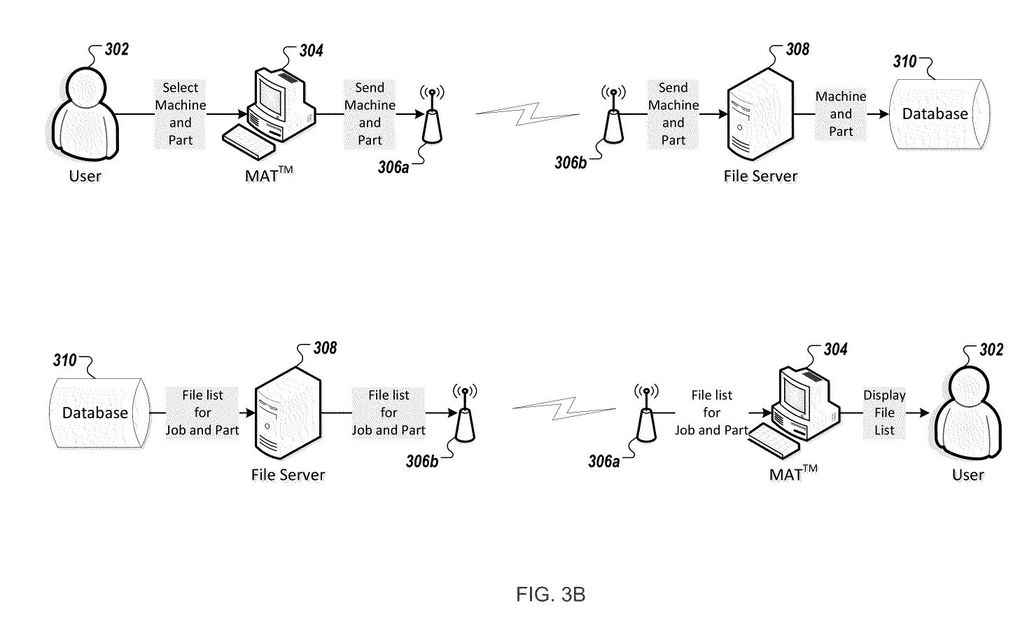

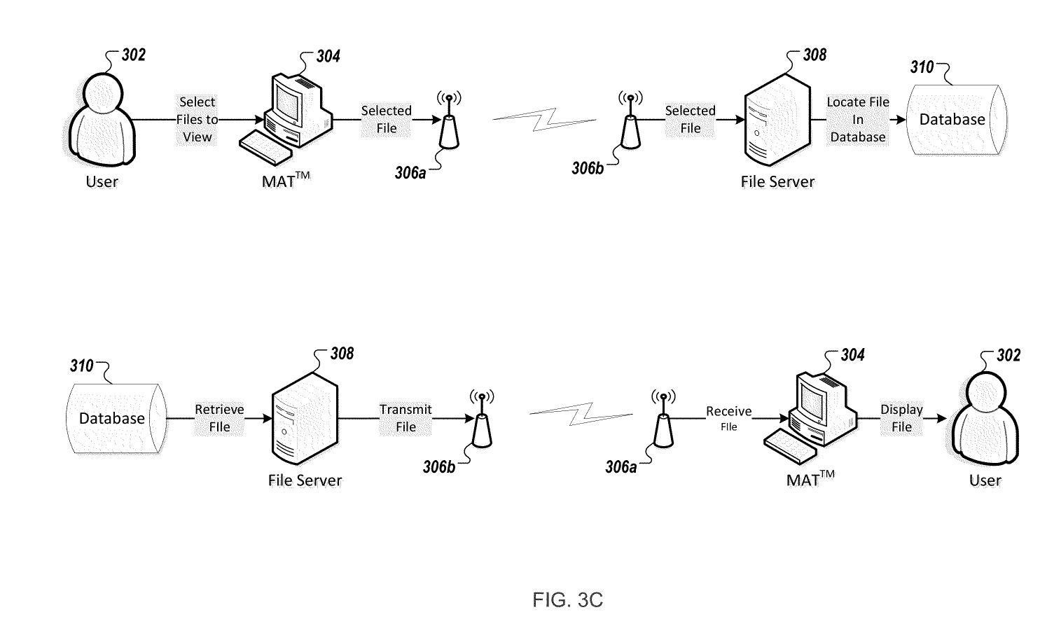

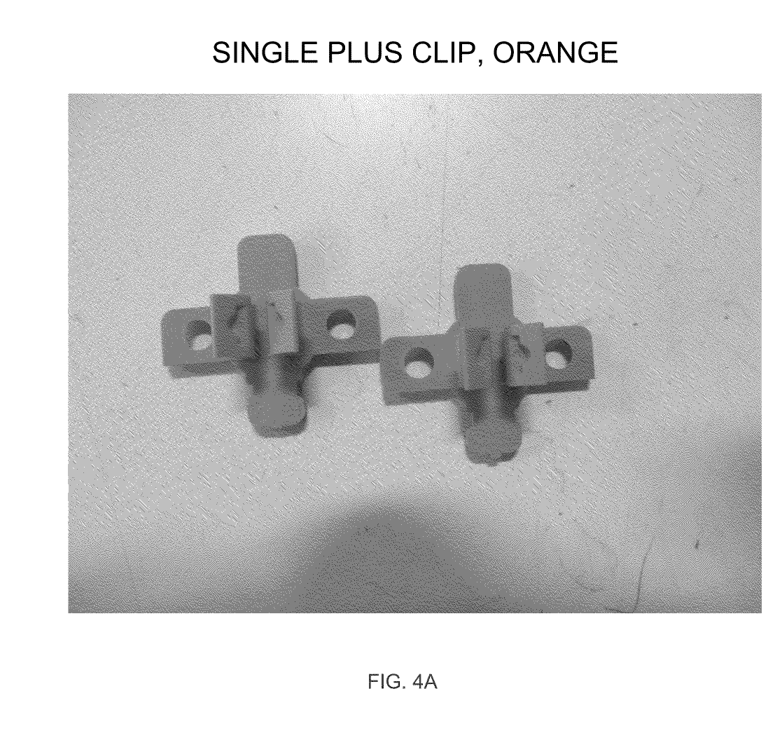

FIG. 3A illustrates a diagram of an example system for log in verification. In some implementations, an operator 302 logs into the mobile automated trainer 304. The mobile automated trainer may transmit the log in information to a file server 308 via wireless transceivers 306. The file server 308 may compare the log in information to information stored in a database 310 to validate the operator name and password. Upon verification, the database may transmit the validation results to the file server 308 which transmits validation to the mobile automated trainer 304. Upon validation, the mobile automated trainer 304 displays a graphical user interface which provides the operator 302 with the ability to select and view electronic training materials on the file server 308 as described in relation to FIGS. 3B and 3C.

FIG. 3B illustrate a diagram of an example mobile automated training system for providing a list of electronic training materials to an operator before, during, or after the operator performs a task associated with the electronic training materials. In some implementations, the list of electronic training materials is a list of one or more electronic training materials that may be accessed using the mobile automated training system. In some implementations, the list of electronic training materials or electronic training materials are displayed as one or more widgets that may be selected by the operator. In some implementations, the one or more widgets is at least one of: a window, a text box, a button, a hyperlink, a drop-down list, a list box, a combo box, a check box, a radio button, a cycle button, a data grid, a spinner, a menu, a menu bar, a toolbar, an icon, a tree view, a grid view, a link, a tab, and/or a scroll bar.

In some implementations, the operator 302 selects or enters a training number associated with a specific machine, part, or task for which the operator 302 wants to receive training using the mobile automated trainer 304. In some implementations, the operator 302 scans a barcode, plugs in a cable associated with a task, machine, or part, docks the mobile automated trainer 304, and/or scans a RFID chip (as discussed above) to provide the FSD with the relevant number. In some implementations, the operator will select a task to perform using a machine, such as manufacturing a part using a CNC machine, and the machine will transmit the information regarding the task to be performed to the mobile automated trainer or the FSD automatically without the operator entering information in the mobile automated trainer. In some implementations, the FSD will determine the relevant task to be performed based on the location of the mobile automated trainer 304. The mobile automated trainer may transmit the training number to a file server 308 via wireless transceivers 306.

The file server 308 may compare the training number to information stored in a database 310 to locate the electronic training materials associated with the training number and hence the machine, part, or task for which the operator wants to receive training. In some implementations, upon identification of the electronic training materials, the database may transmit a list of the electronic training materials to the file server 308 which transmits the list of electronic training materials to the mobile automated trainer 304. In some implementations, upon identification the electronic training materials, the mobile automated trainer 304 displays a graphical user interface on the mobile automated trainer 304 which provides the operator 302 with the ability to view the list of electronic training materials. In some implementations, the list of electronic training materials is stored on the file server 308.

FIG. 3C illustrates a diagram of an example mobile automated training system for providing electronic training materials to an operator before, during, or after the operator performs a task associated with the electronic training materials. In some implementations, the operator 302 selects, using a graphical user interface of the mobile automated trainer software application, one or more electronic training materials to view from the list of electronic training materials provided to the mobile automated trainer 304 as described in relation to FIG. 3B. The mobile automated trainer may transmit a request for the one or more selected electronic training materials to a file server 308 via wireless transceivers 306.

In some implementations, the file server 308 locates and/or receives the requested one or more electronic training materials stored in a database 310. In some implementations, the file server 308 stored the location of the electronic training materials when the file server 308 identified in the electronic training materials, as described in relation to FIG. 3B. In some implementations, the file server 308 fetches the requested one or more selected electronic training materials from the appropriate location. In some implementations, upon receiving of the electronic training materials, the file server 308 transmits the one or more electronic training materials to the mobile automated trainer 304. In some implementations, upon receiving the electronic training materials, a graphical user interface is displayed on the mobile automated trainer 304 which provides the operator 302 with the ability to view the one or more electronic training materials on the file server 308.

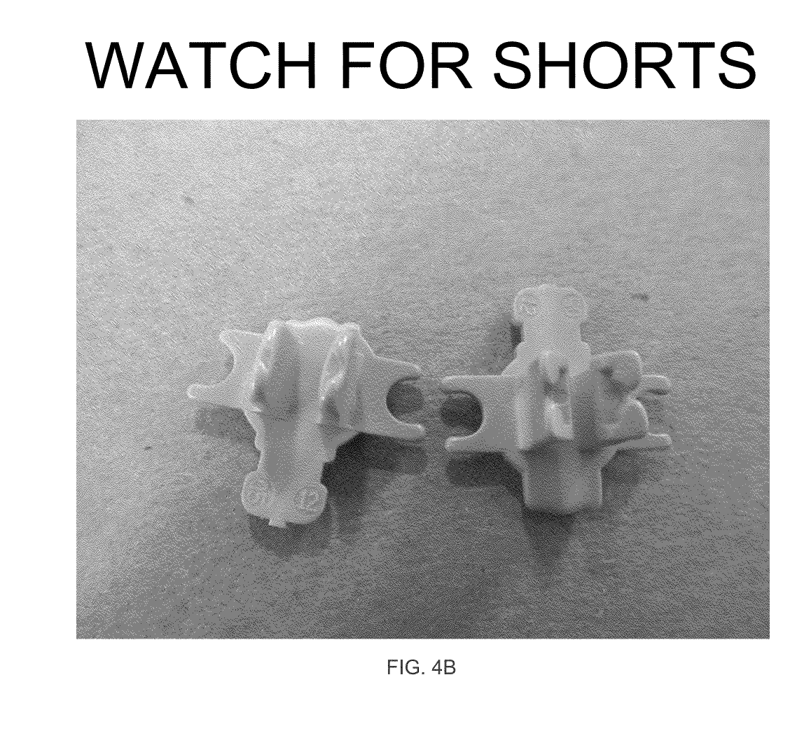

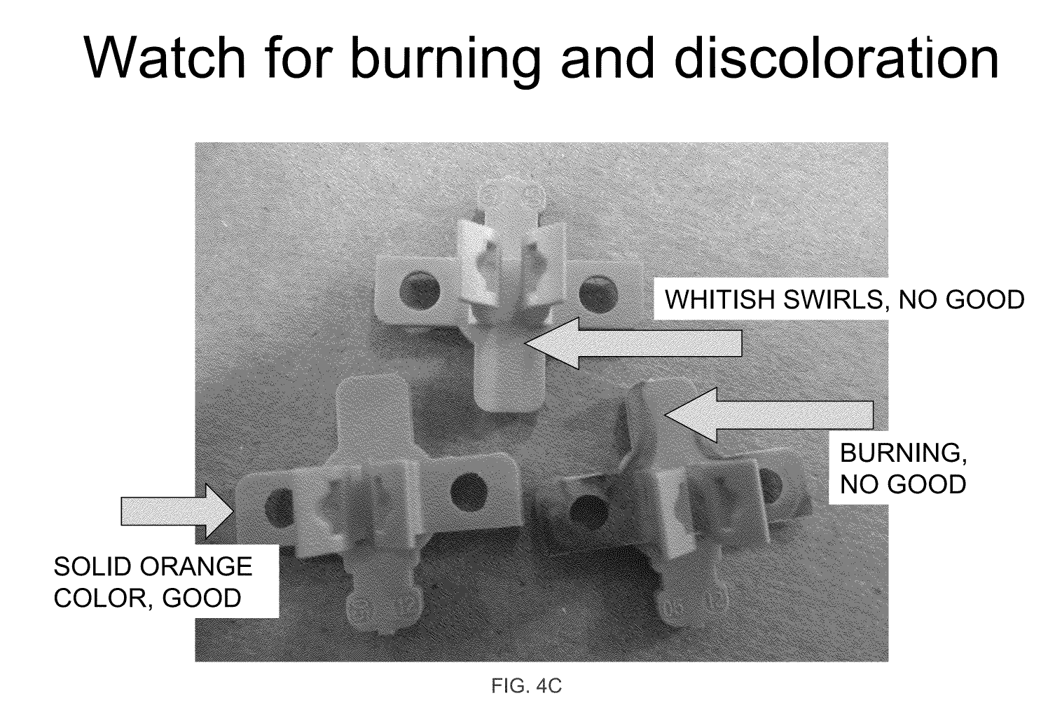

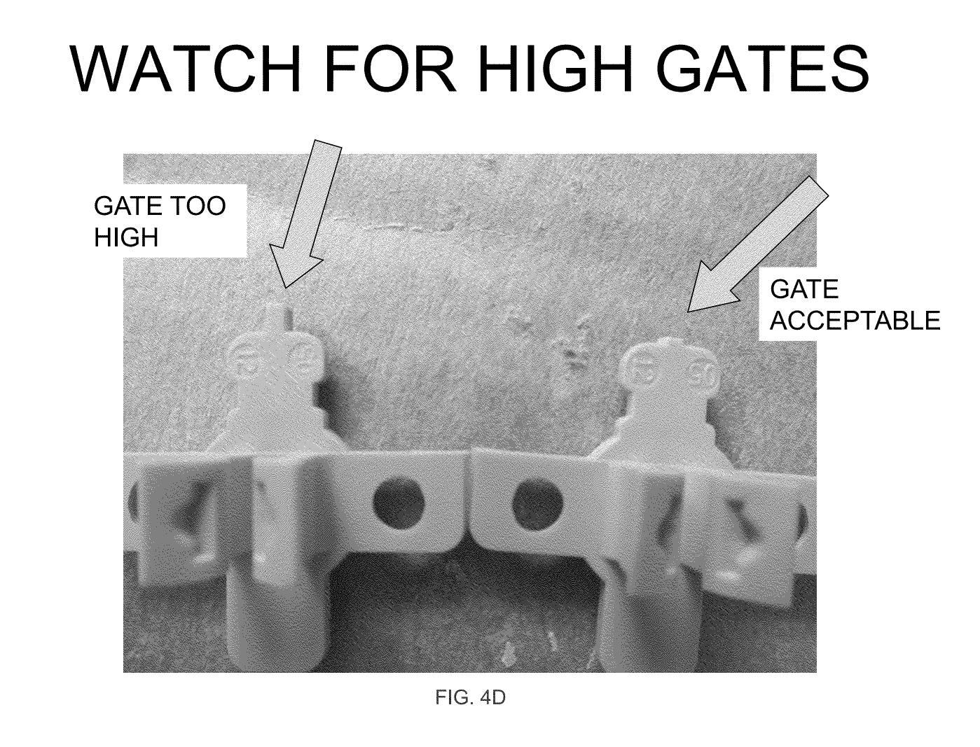

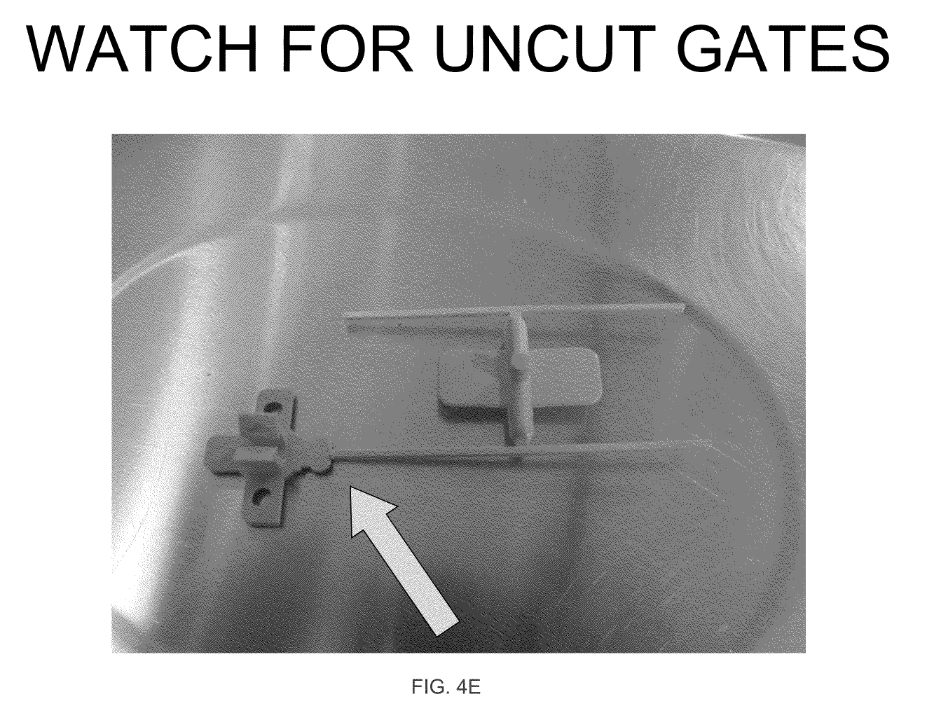

FIGS. 4A through 4E illustrate an example of electronic training materials displayed on the mobile automated trainer. In some implementations, the electronic training materials may be associated with a specific part, machine, or task to be performed by an operator. In some implementations, the electronic training materials include video and/or audio clips explaining visuals provided to the operator on the display of the mobile automated trainer.

As shown in FIG. 4A, in some implementations, the electronic training materials include images of properly formed parts 402. As shown in FIGS. 4B through 4E, in some implementations, the electronic training materials includes examples of parts that were not properly formed. Examples of parts not properly formed may train the operator to identify faulty parts. FIG. 4B is an example of electronic training materials that show a faulty part 404 next to a properly formed part 404. Faulty part 404 includes a short end 406. In some implementations, the electronic training materials include text explaining relevant information. For example, training material shown in FIGS. 4A through 4D includes headings such as “WATCH FOR SHORTS” as shown in FIG. 4B. FIGS. 4C through 4E are examples of electronic training materials depicting parts that are not properly formed.

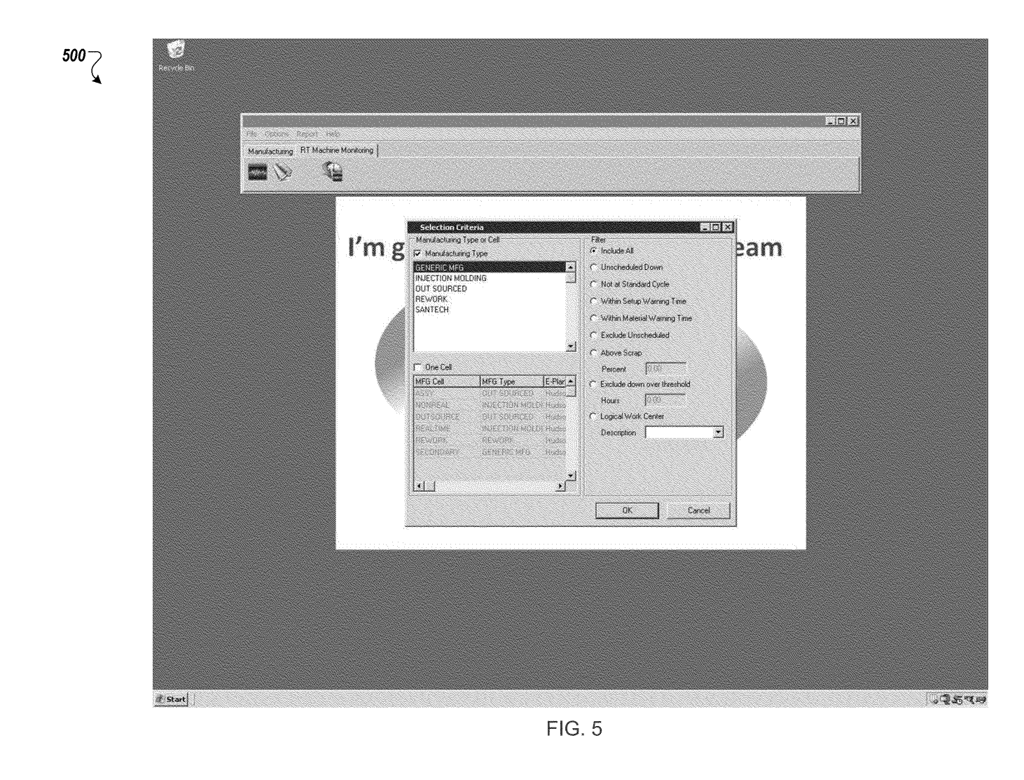

FIG. 5 illustrates an example of a graphical user interface (GUI) 500 shown on the monitor of the mobile automated trainer for selecting electronic training materials. The graphical user interface includes a menu 502 for selecting the type of training that will be performed. For example, the menu may include, in some implementations, different types of manufacturing tasks, such as generic manufacturing, injection molding, outsource manufacturing, and/or rework manufacturing. In some implementations, an operator using the mobile automated trainer may drill down into sub tasks if the manufacturing tasks are broken into multiple sub tasks. In some implementations, the GUI 500 includes a filter menu 504 for selecting the stage in the manufacturing process so that tasks associated with that stage are displayed to the operator using the mobile automated trainer.

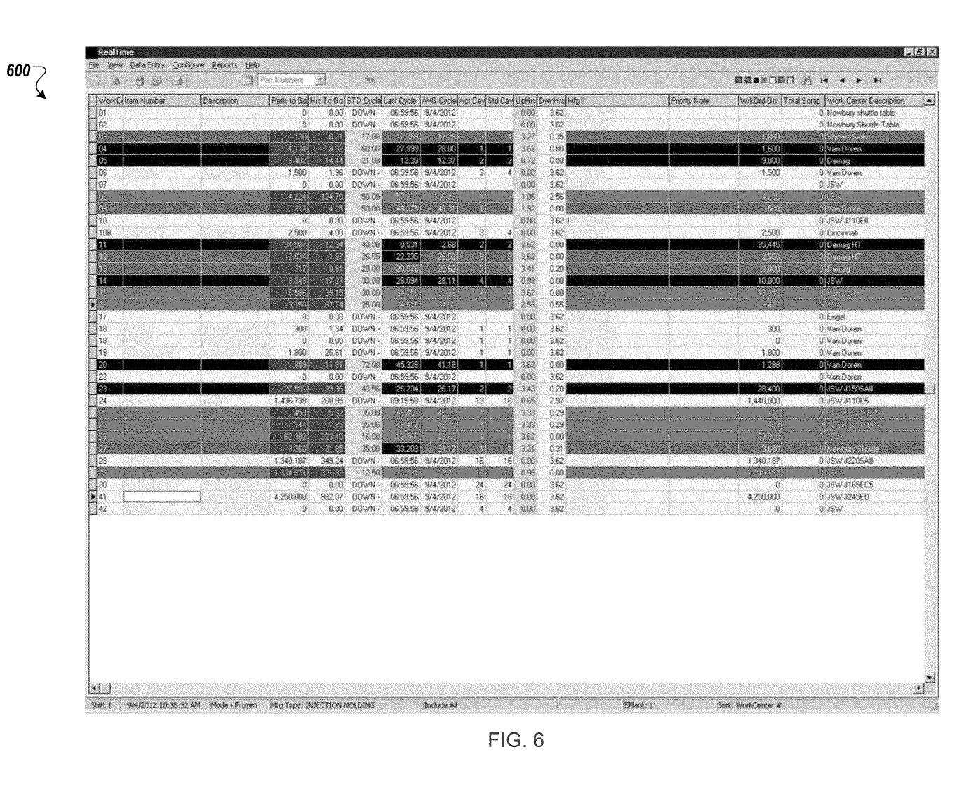

FIG. 6 illustrates an example of a GUI 600 for displaying a list of parts that may be made by a machine. In some implementations, the operator will select a task to perform using a machine, such as, for example, manufacturing a part using a CNC machine, and the machine will transmit the information regarding the task to be performed to the mobile automated trainer or the FSD automatically without the operator entering information in the mobile automated trainer. In some implementations, the FSD will then provide a list of one or more electronic training materials or one or more electronic training materials to the mobile automated trainer for the purpose of training the operator on how to perform the task in relation to the machine, such as, for example, how to perform a task related to manufacturing a part using a CNC machine. In some implementations, the FSD transmits the appropriate electronic training material without user selection from a list of electronic training materials. In some implementations, when the FSD transmits the electronic training material, the actual electronic training materials are not stored locally on the mobile automated trainer computing device. The mobile automated trainer, in some implementations, may use a thin client program for viewing the electronic training materials.

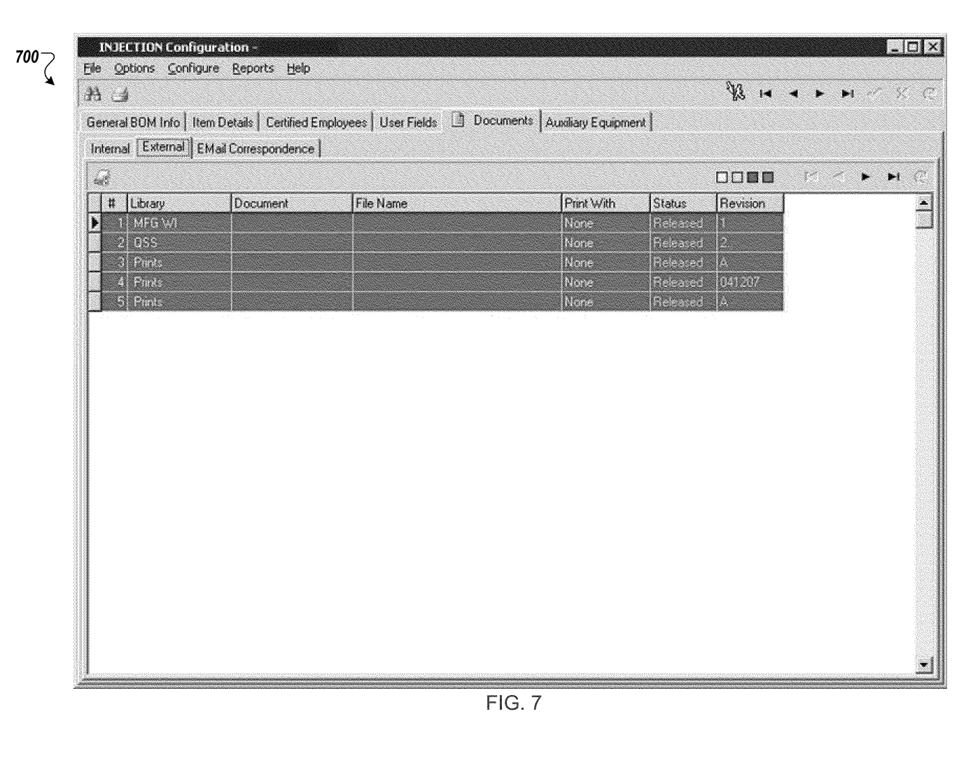

FIG. 7 illustrates an example GUI 700 for displaying a list of one or more electronic training materials associated with a machine, part, or task for which the operator wants to receive training. The operator may, in some implementations, select one or more electronic training materials using GUI 700 for which they would like to receive training. The selected materials will then be displayed on the monitor of the mobile automated trainer in GUI 700 or in a different GUI.

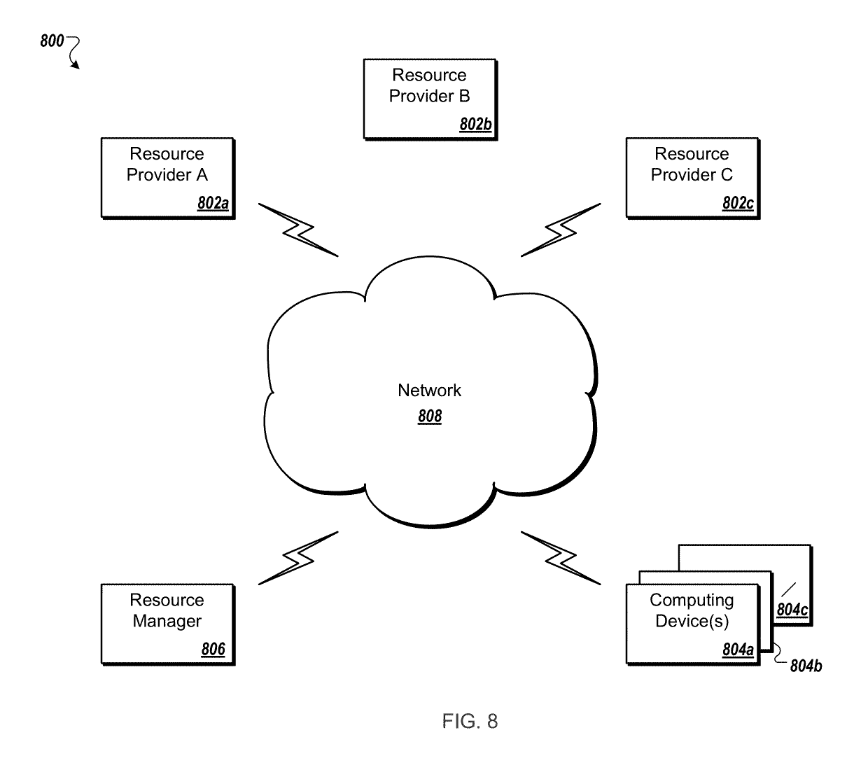

As shown in FIG. 8, an implementation of a network environment 800 for use in mobile automated training is shown and described. In brief overview, referring now to FIG. 8, a block diagram of an exemplary cloud computing environment 800 is shown and described. The cloud computing environment 800 may include one or more resource providers 802a, 802b, 802c (collectively, 802). Each resource provider 802 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 802 may be connected to any other resource provider 802 in the cloud computing environment 800. In some implementations, the resource providers 802 may be connected over a computer network 808. Each resource provider 802 may be connected to one or more computing device 804a, 804b, 804c (collectively, 804), over the computer network 808.

The cloud computing environment 800 may include a resource manager 806. The resource manager 806 may be connected to the resource providers 802 and the computing devices 804 over the computer network 808. In some implementations, the resource manager 806 may facilitate the provision of computing resources by one or more resource providers 802 to one or more computing devices 804. The resource manager 806 may receive a request for a computing resource from a particular computing device 804. The resource manager 806 may identify one or more resource providers 802 capable of providing the computing resource requested by the computing device 804. The resource manager 806 may select a resource provider 802 to provide the computing resource. The resource manager 806 may facilitate a connection between the resource provider 802 and a particular computing device 804. In some implementations, the resource manager 806 may establish a connection between a particular resource provider 802 and a particular computing device 804. In some implementations, the resource manager 806 may redirect a particular computing device 804 to a particular resource provider 802 with the requested computing resource.

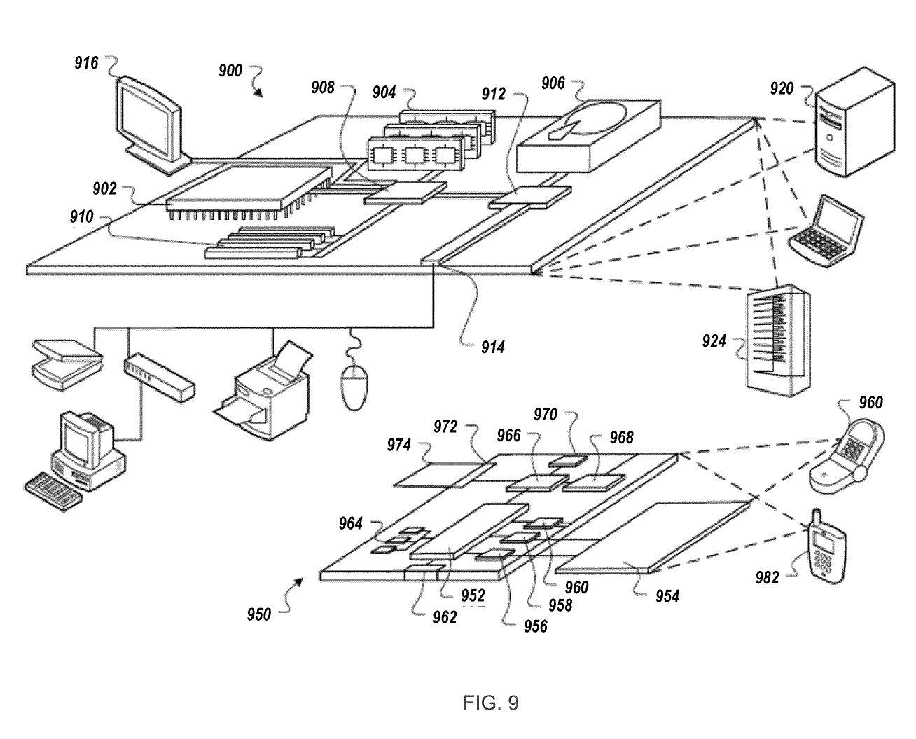

FIG. 9 shows an example of a computing device 900 and a mobile computing device 950 that can be used to implement the techniques described in this disclosure. The computing device 900 is intended to represent various forms of digital computers, such as laptops, desktops, workstations, personal digital assistants, servers, blade servers, mainframes, and other appropriate computers. The mobile computing device 950 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 may also be another form of computer-readable medium, such as a magnetic or optical disk.

The storage device 906 is capable of providing mass storage for the computing device 900. In some implementations, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 902), perform one or more methods, such as those described above. The instructions can also be stored by one or more storage devices such as computer- or machine-readable mediums (for example, the memory 904, the storage device 906, or memory on the processor 902).

The high-speed interface 908 manages bandwidth-intensive operations for the computing device 900, while the low-speed interface 912 manages lower bandwidth-intensive operations. Such allocation of functions is an example only. In some implementations, the high-speed interface 908 is coupled to the memory 904, the display 916 (e.g., through a graphics processor or accelerator), and to the high-speed expansion ports 910, which may accept various expansion cards (not shown). In the implementation, the low-speed interface 912 is coupled to the storage device 906 and the low-speed expansion port 914. The low-speed expansion port 914, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. In addition, it may be implemented in a personal computer such as a laptop computer 922. It may also be implemented as part of a rack server system 924. Alternatively, components from the computing device 900 may be combined with other components in a mobile device (not shown), such as a mobile computing device 950. Each of such devices may contain one or more of the computing device 900 and the mobile computing device 950, and an entire system may be made up of multiple computing devices communicating with each other.

The mobile computing device 950 includes a processor 952, a memory 964, an input/output device such as a display 954, a communication interface 966, and a transceiver 968, among other components. The mobile computing device 950 may also be provided with a storage device, such as a micro-drive or other device, to provide additional storage. Each of the processor 952, the memory 964, the display 954, the communication interface 966, and the transceiver 968, are interconnected using various buses, and several of the components may be mounted on a common motherboard or in other manners as appropriate.

The processor 952 can execute instructions within the mobile computing device 950, including instructions stored in the memory 964. The processor 952 may be implemented as a chipset of chips that include separate and multiple analog and digital processors. The processor 952 may provide, for example, for coordination of the other components of the mobile computing device 950, such as control of user interfaces, applications run by the mobile computing device 950, and wireless communication by the mobile computing device 950.

The processor 952 may communicate with an operator through a control interface 958 and a display interface 956 coupled to the display 954. The display 954 may be, for example, a TFT (Thin-Film-Transistor Liquid Crystal Display) display or an OLED (Organic Light Emitting Diode) display, or other appropriate display technology. The display interface 956 may comprise appropriate circuitry for driving the display 954 to present graphical and other information to an operator. The control interface 958 may receive commands from an operator and convert them for submission to the processor 952. In addition, an external interface 962 may provide communication with the processor 952, so as to enable near area communication of the mobile computing device 950 with other devices. The external interface 962 may provide, for example, for wired communication in some implementations, or for wireless communication in other implementations, and multiple interfaces may also be used.

The memory 964 stores information within the mobile computing device 950. The memory 964 can be implemented as one or more of a computer-readable medium or media, a volatile memory unit or units, or a non-volatile memory unit or units. An expansion memory 974 may also be provided and connected to the mobile computing device 950 through an expansion interface 972, which may include, for example, a SIMM (Single In Line Memory Module) card interface. The expansion memory 974 may provide extra storage space for the mobile computing device 950, or may also store applications or other information for the mobile computing device 950. Specifically, the expansion memory 974 may include instructions to carry out or supplement the processes described above, and may include secure information also. Thus, for example, the expansion memory 974 may be provide as a security module for the mobile computing device 950, and may be programmed with instructions that permit secure use of the mobile computing device 950. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 952), perform one or more methods, such as those described above. The instructions can also be stored by one or more storage devices, such as one or more computer- or machine-readable mediums (for example, the memory 964, the expansion memory 974, or memory on the processor 952). In some implementations, the instructions can be received in a propagated signal, for example, over the transceiver 968 or the external interface 962.

The mobile computing device 950 may communicate wirelessly through the communication interface 966, which may include digital signal processing circuitry where necessary. The communication interface 966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 968 using a radio-frequency. In addition, short-range communication may occur, such as using a Bluetooth®, Wi-Fi™, or other such transceiver (not shown). In addition, a GPS (Global Positioning System) receiver module 970 may provide additional navigation- and location-related wireless data to the mobile computing device 950, which may be used as appropriate by applications running on the mobile computing device 950.

The mobile computing device 950 may also communicate audibly using an audio codec 960, which may receive spoken information from an operator and convert it to usable digital information. The audio codec 960 may likewise generate audible sound for an operator, such as through a speaker, e.g., in a handset of the mobile computing device 950. Such sound may include sound from voice telephone calls, may include recorded sound (e.g., voice messages, music electronic training materials, etc.) and may also include sound generated by applications operating on the mobile computing device 950.

The mobile computing device 950 may be implemented in a number of different forms, as shown in the figure. For example, it may be implemented as a cellular telephone 980. It may also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with an operator, the systems and techniques described here can be implemented on a computer having a display device (e.g., a CRT (cathode ray tube) or LCD (liquid crystal display) monitor) for displaying information to the operator and a keyboard and a pointing device (e.g., a mouse or a trackball) by which the operator can provide input to the computer. Other kinds of devices can be used to provide for interaction with an operator as well; for example, feedback provided to the operator can be any form of sensory feedback (e.g., visual feedback, auditory feedback, or tactile feedback); and input from the operator can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which an operator can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for mobile automated training are provided. Having described certain implementations of methods and apparatus for supporting mobile automated training, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

What is claimed:

1. A mobile automated training apparatus comprising:
a mobile stand configured for motility between at least two training locations in a facility;
a video monitor attached to the mobile stand, the video monitor being adjustable between at least two height positions;
a processor; and
a non-transitory computer readable medium storing instructions thereon wherein the instructions, when executed, cause the processor to:
display one or more GUI widgets on the monitor for selection by an operator, wherein each of the one or more GUI widgets corresponds to a set of electronic training materials to be presented on the video monitor; and
upon selection of one of the one or more GUI widgets by the operator, display the corresponding set of electronic training materials on the video monitor.

2. The apparatus of claim 1, wherein each of the at least two training locations comprises a location at which a task is performed by the operator, wherein the set of electronic training materials displayed on the video monitor relate to the task performed at said location.

3. The apparatus of claim 1, wherein the mobile stand configured for motility between at least two training locations in a facility comprises one or more wheels for moving the mobile stand between the at least two training locations.

4. The apparatus of claim 1, wherein the facility is at least one of a manufacturing facility, a hotel, a kitchen, an office, bar, academic institution, medical facility, and operating room.

5. The apparatus of claim 1, wherein the mobile automated training apparatus further comprises a user interface device comprising at least one of a keyboard, a computer mouse, a trackball, a touch screen, a hands free communication device, and a microphone, said user interface device configured to facilitate selection of the graphical user interface widgets by the operator.

6. The apparatus of claim 1, wherein the video monitor comprises a touch screen configured to facilitate selection of the graphical user interface widgets by the operator.

7. The apparatus of claim 1, wherein the one or more graphical user interface widgets comprises one or more members selected from the group consisting of a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and a scroll bar.

8. The apparatus of claim 1, wherein the set of electronic training materials comprises one or more members selected from the group consisting of a part description, a diagram, an operation instruction, a slideshow, a video, an audio message, and a training instruction manual.

9. The apparatus of claim 1, wherein the set of electronic training materials is version-controlled.

10. The apparatus of claim 1, wherein the video monitor is adjustable between a first position for viewing by a sitting operator and a second position for viewing by a standing operator.

11. A method comprising:
displaying, at a computing device of a mobile automated training apparatus, one or more GUI widgets, each corresponding to a set of electronic training materials for display on a video monitor of the mobile automated training apparatus;
identifying, at the computing device of the mobile automated training apparatus, an operator selection of one of the one or more GUI widgets;
receiving from a file server, at the computing device of the mobile automated training apparatus, a version-controlled set of electronic training materials for display on a video monitor of the mobile automated training apparatus, wherein the set of electronic training materials corresponds to the selected GUI widget.

12. The method of claim 11, wherein the mobile automated training apparatus is configured for motility between at least two training locations in a facility.

13. The method of claim 12, wherein the set of electronic training materials relates to a task performed by an operator of the mobile automated training apparatus at one of the at least two training locations.

14. The method of claim 12, wherein the facility is at least one of a manufacturing facility, a hotel, a kitchen, an office, bar, academic institution, medical facility, and operating room.

15. The method of claim 11, wherein the mobile automated training apparatus comprises a user interface device comprising at least one of a keyboard, a computer mouse, a trackball, a touch screen, a hands free communication device, and a microphone, said user interface device configured to facilitate selection of the graphical user interface widgets by the operator.

16. The method of claim 11, wherein the one or more graphical user interface widgets comprises one or more members selected from the group consisting of a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and a scroll bar.

17. The method of claim 11, wherein the version-controlled set of electronic training materials comprises one or more members selected from the group consisting of a part description, a diagram, an operation instruction, a slideshow, a video, an audio message, and a training instruction manual.

18. A system comprising:
(a) a mobile automated training apparatus comprising:
a mobile stand configured for motility between at least two training locations in a facility;
a video monitor attached to the mobile stand, the video monitor being adjustable between at least two height positions;
a processor; and
a non-transitory computer readable medium storing instructions thereon wherein the instructions, when executed, cause the processor to:
display one or more GUI widgets on the monitor for selection by an operator, wherein each of the one or more GUI widgets corresponds to a set of version-controlled electronic training materials to be presented on the video monitor;
upon selection of one of the one or more GUI widgets by the operator, receive a set of version-controlled electronic training materials corresponding to the selected GUI widget from a file server; and
display the corresponding set of version-controlled electronic training materials on the video monitor; and
(b) a file server configured to:
store a version-controlled set of electronic training materials corresponding to each of the one or more GUI widgets; and
transmit the set of version-controlled electronic training materials corresponding to the selected GUI widget to the processor of the mobile automated training apparatus.

19. The system of claim 18, wherein each of the at least two training locations comprises a location at which a task is performed by the operator, wherein the set of electronic training materials displayed on the video monitor relate to the task performed at said location.

20. The system of claim 18, wherein the mobile stand configured for motility between at least two training locations in a facility comprises one or more wheels for moving the mobile stand between the at least two training locations.

21. The system of claim 18, wherein the facility is at least one of a manufacturing facility, a hotel, a kitchen, an office, bar, academic institution, medical facility, and operating room.

22. The system of claim 18, wherein the mobile automated training apparatus further comprises a user interface device comprising at least one of a keyboard, a computer mouse, a trackball, a touch screen, a hands free communication device, and a microphone, said user interface device configured to facilitate selection of the graphical user interface widgets by the operator.

23. The system of claim 18, wherein the video monitor comprises a touch screen configured to facilitate selection of the graphical user interface widgets by the operator.

24. The system of claim 18, wherein the one or more graphical user interface widgets comprises one or more members selected from the group consisting of a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and a scroll bar.

25. The system of claim 18, wherein the set of electronic training materials comprises one or more members selected from the group consisting of a part description, a diagram, an operation instruction, a slideshow, a video, an audio message, and a training instruction manual.

26. The system of claim 18, wherein the video monitor is adjustable between a first position for viewing by a sitting operator and a second position for viewing by a standing operator.
